(19) United States
(12) Patent Application Publication
(10) Pub. No.: US 2025/0148262 A1
(43) Pub. Date: May 8, 2025

(54) METHOD AND APPARATUS WITH FEATURE-LEVEL ENSEMBLE MODEL

(71) Applicant: Samsung Electronics Co., Ltd., Suwon-si (KR)

(72) Inventors: Wonjun CHOI, Suwon-si (KR); Byung In YOO, Suwon-si (KR); Dongwook LEE, Suwon-si (KR)

(73) Assignee: Samsung Electronics Co., Ltd., Suwon-si (KR)

(21) Appl. No.: 18/642,167

(22) Filed: Apr. 22, 2024

(30) Foreign Application Priority Data
Nov. 3, 2023 (KR) 10-2023-0151065

(51) Int. Cl. G06N 3/045; G06N 5/022

(52) U.S. Cl. CPC G06N 3/045; G06N 5/022

(57) ABSTRACT

A method and apparatus with a feature-level ensemble model are provided. A method of operating an ensemble model based on feature-level consolidation includes: obtaining queries by inputting a same input data item to respective transformer models, the transformer models generating respective queries from the input data item; forming an ensemble query corresponding to the queries; and generating a predicted value of the input data item by applying the ensemble query to a prediction model that includes a transformer decoder, the prediction model inferring the predicted value from the ensemble query.

### CROSS-REFERENCE TO RELATED APPLICATIONS

This application claims the benefit under 35 USC § 119(a) of Korean Patent Application No. 10-2023-0151065, filed on Nov. 3, 2023, in the Korean Intellectual Property Office, the entire disclosure of which is incorporated herein by reference for all purposes.

### BACKGROUND

### 1. Field

The following description relates to a method and apparatus with feature-level ensemble.

### 2. Description of Related Art

In the field of deep learning technology, an ensemble model, which is an ensemble of multiple trained models produces, for a given input, outputs final results based on results of the multiple trained models. The final results of the ensemble model may be superior to the results of individual models and thus an ensemble model may overcome shortcomings and improve performance of the individual trained models. For example, object detection may be improved through an ensemble of object detection models trained to infer bounding boxes for input images. Various techniques have been used to decide how bounding boxes of an ensemble model of object detection models will be used as final inference results of a model. For example, bounding boxes may be filtered or merged based on their intersection over union (IoU) values (a measure of degree of overlap of two boxes). In addition, to utilize more information, technology is being developed that performs ensemble processing at the feature level.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a method of operating an ensemble model based on feature-level consolidation includes: obtaining queries by inputting a same input data item to respective transformer models, the transformer models generating respective queries from the input data item; forming an ensemble query corresponding to the queries; and generating a predicted value of the input data item by applying the ensemble query to a prediction model that includes a transformer decoder, the prediction model inferring the predicted value from the ensemble query.

The forming of the ensemble query may include: inputting the queries to respective projection networks that project the queries to respective projected queries that share a same feature space; and wherein the ensemble query may be a concatenation of the projected queries.

The prediction model may include the transformer decoder and a prediction network that may generate the predicted value.

The generating of the predicted value of the input data item may include: obtaining output embedding data by applying the ensemble query to the transformer decoder; and obtaining the predicted value of the input data item by applying the output embedding data to the prediction network.

The input data item may include an image or a point cloud, and the predicted value of the input data item may include a bounding box of an object detected in the input data item or class information of the object.

The prediction model may include: a network configured for bounding box regression for object detection and configured for a class estimation of an object corresponding to a bounding box.

The prediction model may include: a neural network trained based on a loss function related to a difference between the predicted value of the input data item and ground truth data of the input data item.

The projection networks and the prediction model may include: a neural network trained based on a loss function related to a difference between the predicted value of the input data item and ground truth data of the input data item.

The queries may have different dimensions and the ensemble query may be based on respective transformations of the queries that have a same dimension.

In another general aspect, a method of training an ensemble model based on feature-level consolidation includes: obtaining queries by inputting a same training data item to respective transformer-based models, the transformer models generating respective queries from the training data item; obtaining an ensemble query corresponding to the plurality of queries; obtaining an estimated value of the training data item by applying the ensemble query to a prediction model including a transformer decoder; and training the prediction model based on a loss function related to a difference between the estimated value of the training data item and ground truth data of the training data item.

The obtaining of the ensemble query may include: obtaining projected queries corresponding to the queries based on respective projection networks that embed the queries into a same feature space; and obtaining an ensemble query by concatenating the projected queries.

The training of the prediction model may include: training the prediction model and the projection network based on the loss function.

The training data item may include an image or a point cloud, the estimated value of the training data item may include a bounding box of an object detected in the input data item and a classification of the object, and the prediction model includes a network that is configured for bounding box regression for object detection and classification in the training data item.

The obtaining of the estimated value of the training data item may include: obtaining output embedding data by applying the ensemble query to the transformer decoder of the prediction model; and obtaining an estimated value of the training data item by applying the output embedding data to a prediction network of the prediction model, the prediction model inferring the estimated value of the training data item from the output embedding data.

The transformer models may each be configured for object detection and each may encode the input data item, and wherein transformer decoder decodes a concatenation of transformations of the respective queries.

In another general aspect, an apparatus includes one or more processors configured to: generate, by transformer-based models, respective queries corresponding to an input data item inputted to the transformer-based models; obtain an ensemble query corresponding to the queries; and obtain a predicted value of the input data item by applying the ensemble query to a prediction model including a transformer decoder.

The one or more processors may be further configured to, in obtaining the ensemble query: obtain projected queries respectively corresponding to the queries, wherein the projected queries are obtained based on a projection network that projects the queries into the projected queries which are in a same feature space; and the ensemble query may include a concatenation of the projected queries.

The projection network and the prediction model may include: a neural network trained based on a loss function related to a difference between the estimated value of the input data item and ground truth data of the input data item.

The one or more processors may be further configured to: train the projection network and the prediction model based on a loss function related to a difference between the estimated value of the input data item and ground truth data of the input data item.

The input data item may include an image and a point cloud, the predicted value of the input data item may include a bounding box of an object detected in the input data item or a classification of the object.

Other features and aspects will be apparent from the following detailed description, the drawings, and the claims.

### BRIEF DESCRIPTION OF THE DRAWINGS

FIG. 1 illustrates an example operation of a feature-level ensemble model, according to one or more embodiments.

FIG. 2 illustrates an example of a structure of a transformer-based model, according to one or more embodiments.

FIG. 3 illustrates an example of a structure of a model based on feature-level ensemble, according to one or more embodiments.

FIG. 4 illustrates an example of an object detection model based on feature-level ensemble, according to one or more embodiments.

FIG. 5 illustrates an example of a training method based on feature-level ensemble, according to one or more embodiments.

FIG. 6 illustrates an example of a training method based on feature-level ensemble, according to one or more embodiments.

FIG. 7 illustrates an example configuration of an apparatus, according to one or more embodiments.

Throughout the drawings and the detailed description, unless otherwise described or provided, the same or like drawing reference numerals will be understood to refer to the same or like elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known after an understanding of the disclosure of this application may be omitted for increased clarity and conciseness.

The features described herein may be embodied in different forms and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

The terminology used herein is for describing various examples only and is not to be used to limit the disclosure. The articles “a,” “an,” and “the” are intended to include the plural forms as well, unless the context clearly indicates otherwise. As used herein, the term “and/or” includes any one and any combination of any two or more of the associated listed items. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof.

Throughout the specification, when a component or element is described as being “connected to,” “coupled to,” or “joined to” another component or element, it may be directly “connected to,” “coupled to,” or “joined to” the other component or element, or there may reasonably be one or more other components or elements intervening therebetween. When a component or element is described as being “directly connected to,” “directly coupled to,” or “directly joined to” another component or element, there can be no other elements intervening therebetween. Likewise, expressions, for example, “between” and “immediately between” and “adjacent to” and “immediately adjacent to” may also be construed as described in the foregoing.

Although terms such as “first,” “second,” and “third”, or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

Unless otherwise defined, all terms, including technical and scientific terms, used herein have the same meaning as commonly understood by one of ordinary skill in the art to which this disclosure pertains and based on an understanding of the disclosure of the present application. Terms, such as those defined in commonly used dictionaries, are to be interpreted as having a meaning that is consistent with their meaning in the context of the relevant art and the disclosure of the present application and are not to be interpreted in an idealized or overly formal sense unless expressly so defined herein. The use of the term “may” herein with respect to an example or embodiment, e.g., as to what an example or embodiment may include or implement, means that at least one example or embodiment exists where such a feature is included or implemented, while all examples are not limited thereto.

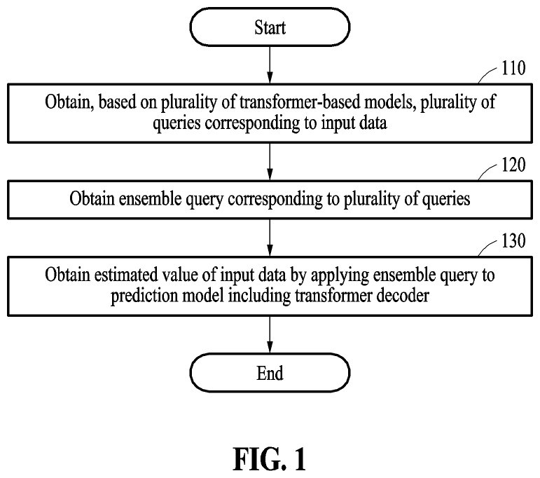

FIG. 1 illustrates an example of an operation of a feature-level ensemble model, according to one or more embodiments.

A model based on feature-level consolidation may include a model trained by a feature-level ensemble algorithm and may be referred to herein as a ‘model’ or an ‘ensemble model’. The ensemble model may be trained to perform a specific task by an ensemble model training algorithm. For example, the ensemble model may perform an object detection task on an input image. The ensemble model may be based on a transformer type of neural network. For example, the ensemble model may be an ensemble of transformer networks that share a transformer decoder. The ensemble model may also be referred to as a feature-level ensemble because inference results of constituent networks (e.g., transformer-based networks) are combined/consolidated based on their features, which may be taken into account at the point of merger of the constituent results, for example. For example, the constituent networks (transformer-based networks) may each have their own encoder, but their respective inference results on an input data item may be consolidated by a common decoder (e.g., a transformer decoder) which may generates a final inference of the ensemble model. A specific example structure of the model is described below.

Various of the models mentioned herein may be neural network models. Such a neural network model may include interconnected layers of nodes. The nodes of adjacent layers may have weighted connections therebetween (connections between non-adjacent layers are also possible). The neural network model may include an input layer, a hidden layer, and an output layer. The output of a layer (e.g., the output layer) may be generated by an activation function. Updating the neural network model by training may include changing weights of the connections, for example.

A method of operating the ensemble model may include operation 110 of obtaining, based on multiple transformer-based models, respective queries corresponding to and derived based on a same input data. Each transformer-based model may generate its query through a transformer decoder (e.g., a shared decoder). For example, the transformer-based models may be transformer models that have a shared decoder, e.g., transformer decoder 351.

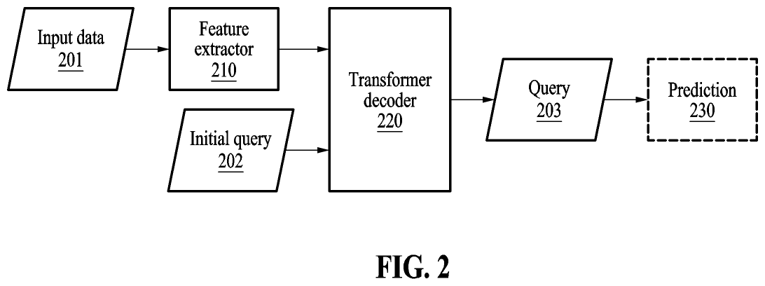

An example of a transformer-based model is shown in FIG. 2, according to one or more embodiments. Referring to FIG. 2, the example transformer-based model may include a feature extractor 210 that extracts a feature from input data 201 (the same input data item that is provided to the other transformer-based models). The transformer-based model may include a transformer decoder 220 that outputs a query 203 (a transformer type of query) from a feature extracted by the feature extractor 210 and from an initial query 202 (general transformer-based generation of initial queries is described elsewhere). For example, an initial query may be a vector with randomly extracted values. A prediction 230 operation for performing a desired task (e.g., object detection) may be performed based on the query 203 output by the transformer decoder 220. The queries obtained based on the input data in operation 110 may include the query 203 that is inferred and output by the transformer decoder 220 of the transformer-based model based on the input data 201.

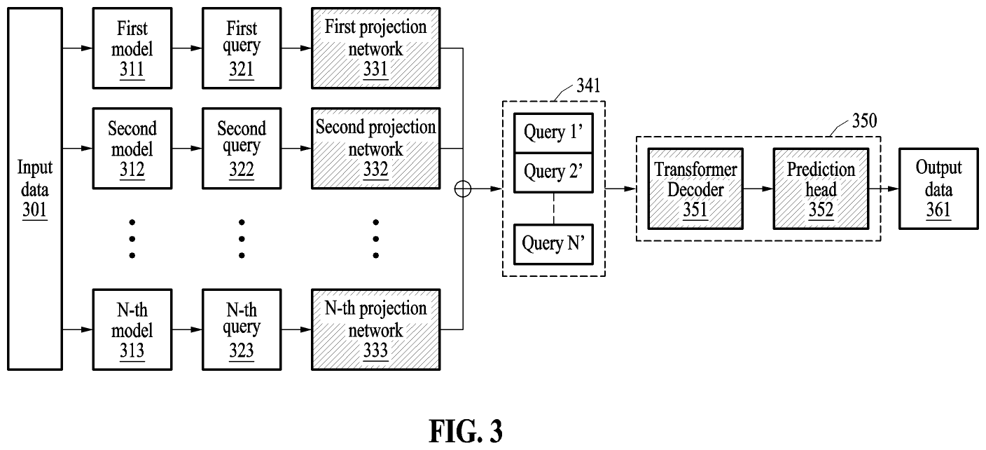

Referring again to FIG. 1, the ensemble model may obtain queries (e.g., queries 321 . . . 323 in FIG. 3) corresponding to the same input data from two or more respective transformer-based models (e.g., the transformer-based model in FIG. 2). The transformer-based models may be to different models trained independently from each other (e.g., potentially having different weights, different hyperparameters, and mapping some same inputs to different outputs). For example, structures of the transformer-based models may be different from each other. In addition, sizes/dimensions of the queries (e.g., queries 321 . . . 323 in FIG. 3, which may be instances of query 203) output from the respective transformer-based models may differ among the queries.

Referring to FIG. 1, the method of operating the ensemble model may include operation 120 of obtaining an ensemble query (e.g., ensemble query 341 in FIG. 3), corresponding to the queries outputted by the transformer-based models. For example, the ensemble query may correspond be generated by performing an ensemble operation on the queries, e.g., concatenation. For example, the ensemble query may be generated by ensembling data (e.g., projected queries) that is obtained by converting/transforming (e.g., projecting) the queries according to a determined conversion standard/formula/rule.

Operation 120 of obtaining the ensemble query may include obtaining projected queries respectively corresponding to the queries, which may be performed by projection networks (e.g., projection networks 331 . . . 323 in FIG. 3) associated with the respective transformer-based networks. The projection networks may be for embedding the respective queries into a same feature space. The projection networks may be configured to embed queries, which may have varying dimensions (as obtained from the respective different transformer-based models) to the same feature space. For example, the projection networks may each include a linear layer for converting the corresponding queries obtained from different transformer-based models (which may have different dimensions) to projected queries that all have the same dimension. The linear layer is only an example of the projection network; the projection networks may have a different structure and may include one or more other layers.

As noted, projection networks may generate projected queries respectively corresponding the queries. The projected queries output from the respective projection networks and may be vectors embedded to the same feature space. For example, when the projection networks each convert respective input data (e.g., queries) to output data of a size 1×D, the projected queries output from each of the projection networks may correspond to data of the size 1×D.

As noted, there may be multiple projections networks, which together may form an ensemble projection network, which may respectively corresponding to the queries. For example, referring to FIG. 3, when there are N transformer-based models (a first model 311, a second model 312, . . . and an N-th model 313), there may be N queries, e.g., a first query 321 obtained based on input data 301 by the first model 311, a second query 322 obtained based on the input data 301 by the second model 312, . . . and an N—the query 323 obtained based on the input data 301 by the N-th model 313. In this case, the ensemble projection network may include N projection networks, including a first projection network 331 for projection of the first query 321, a second projection network 332 for projection of the second query 322, . . . and an N-th projection network 333 for projection of the N-th query 323.

Referring again to FIG. 1, operation 120 of obtaining an ensemble query may include concatenating or otherwise combining the projected queries, which may respectively correspond to the transformer-based models.

Referring to FIG. 3, the projected queries that are outputs of N projection networks 331, 332, . . . and 333 may also b referred to as query i′ (i=1, . . . , N), an ensemble query 341 may be generated by concatenating the projected queries that are the outputs of the projection networks 331, 332, . . . and 333. For example, when the N projected queries (Query 1′ . . . Query N′) each has a size 1×D, the ensemble query 341 generated by concatenating them may form a tensor of a size N×D.

Referring again to FIG. 1, the method of operating the ensemble model may include operation 130 of obtaining an estimated/predicted value (e.g., output data 361) of the input data by applying the ensemble query 341 to a prediction model (e.g., prediction model 350) including the transformer decoder 220. The prediction model may output an estimated value corresponding to a task of the ensemble model from the ensemble query. The prediction model may be a training model that includes at least one layer.

The prediction model may include a transformer decoder and a prediction network. Operation 130 of obtaining an estimated value of the input data may include obtaining output embedding data by applying the ensemble query to the transformer decoder (e.g., transformer decoder 351) of the prediction model, and obtaining the estimated value of the input data by applying the output embedding data to the prediction network of the prediction model.

For example, referring to FIG. 3, the ensemble model may include a prediction model 350 including a transformer decoder 351 and a prediction head 352, which may be the prediction network. The ensemble query 341 may be input to the transformer decoder 351, and the transformer decoder 351 may output output embedding data corresponding to the ensemble query 341. The output embedding data output from the transformer decoder 351 may be input to the prediction head 352. The prediction head 352 may output output data 361 corresponding to the output embedding data. The output data 361 may correspond to an estimated value corresponding to input data generated according to a task performance of the model.

The projection network and the prediction model may include a neural network trained based on a loss function related to a difference between the estimated value of the input data and ground truth data of the input data. A training method of the model is described below.

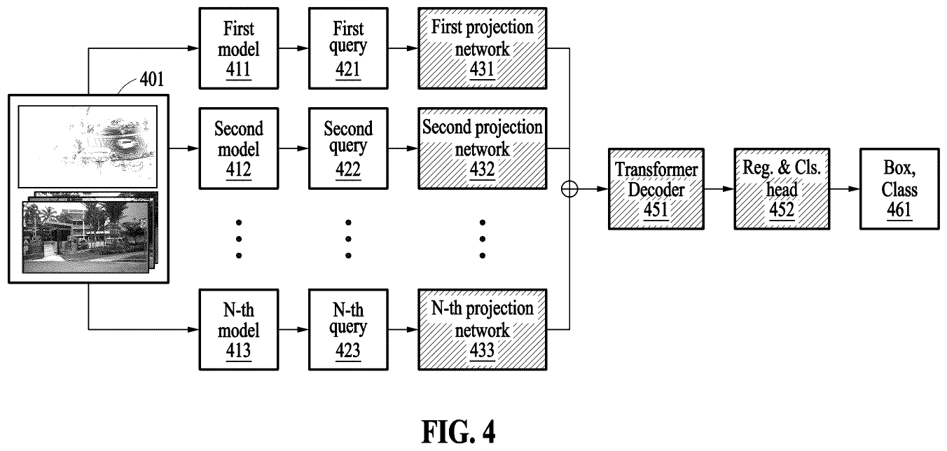

FIG. 4 illustrates an example structure of an object detection model based on feature-level ensemble, according to one or more embodiments.

An object detection model shown in FIG. 4 may correspond to the model based on feature-level ensemble described above with reference to FIGS. 1 to 3 and may be a model that performs an object detection task.

Referring to FIG. 4, input data 401 of the object detection model may include at least one of an image and a point cloud. Output data 461 of the object detection model may be an estimated value of the input data 401 and may include bounding box information of an object detected in the input data 401 and/or class information of the detected object. In other words, the bounding box information (indicating an area of the object included in the input image and/or the point cloud) and/or the class (or classification) information of the object included in the input image and/or the point cloud may be output from the model as the estimated/predicted value of the input data 401.

The object detection model may obtain queries 421, 422, and 423 corresponding to the input data 401, and may do so based on respective transformer-based models 411, 412, and 413 (applied to the input data 401). Here, the queries 421, 422, and 423 may correspond to object queries (known query-generating techniques may be used). The of transformer-based models 411, 412, and 413 may be configured for object detection, e.g., may each be/include a transformer-based model for object detection.

The queries 421, 422, and 423 may be converted to projected queries corresponding to a same feature space based on projection networks 431, 432, and 433. As described above, the queries 421, 422, and 423 may be converted (based on the projection networks 431, 432, and 433) to the respective projected queries such that the projected queries have a same dimension.

An ensemble query generated by concatenating the projected queries may be applied to a transformer decoder 451. The transformer decoder 451 may output output embedding data corresponding to the ensemble query, and the output embedding data may be input to a prediction network 452.

The prediction network 452 may include a network that is (i) configured and trained for bounding box regression for object detection of objects in the input data 401 and that is (ii) for class estimation of an object corresponding to a bounding box. The prediction network 452 may (i) estimate a bounding box indicating an area of an object in the input data 401 and may (ii) estimate a class value (or values) of an object included in the bounding box. Estimating the bounding box may involve (i) specifying a location of an area occupied by (or containing) the object in the input data 401 or (ii) determining coordinates of the area occupied by the object. The class value of the object included in the bounding box may identify a type of the object (e.g., person, dog, cat, truck, etc.). In some implementations, an outline or precise delimitation of the object is not provided, rather the bounding box is assumed to contain the object (not necessarily completely), and the class of the bounding box serves as the class of the implicitly detected/recognized object.

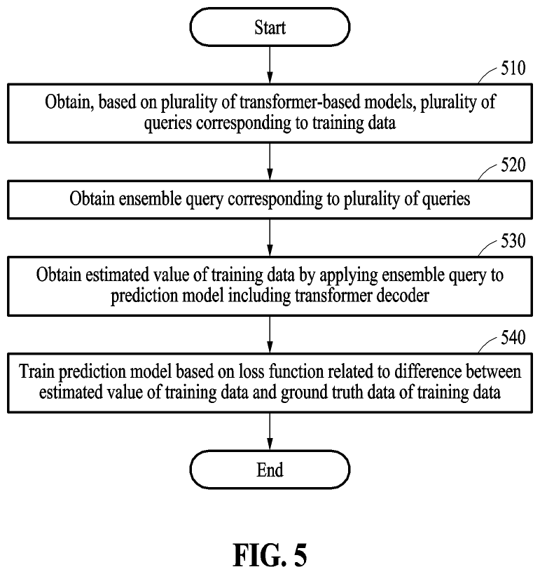

FIG. 5 illustrates an example of a training method based on a feature-level ensemble model, according to one or more embodiments.

Referring to FIG. 5, the training method may include operation 510 of obtaining, based on transformer-based models, respective queries corresponding to training data. Operation 510 of the training method may correspond to operation 110 described above with reference to FIG. 1, except that input data is training data that includes ground truth data.

The training method may include operation 520 of obtaining an ensemble query from the queries. Operation 520 of the training method may correspond to operation 120 of FIG. 1. For example, operation 520 of obtaining an ensemble query may include obtaining projected queries respectively corresponding to the queries based on respectively corresponding projection networks for embedding the queries into a same feature space; the ensemble query may be generated by concatenating the projected queries.

The training method may include operation 530 of obtaining an estimated value of the training data by applying the ensemble query to a prediction model that includes a transformer decoder. Operation 530 of the training method may correspond to operation 130 of FIG. 1, again, using training data rather than input data for which a final object detection result is to be generated.

The training method may include operation 540 of training the prediction model based on a loss function related to a difference between the estimated value estimated from the training data and the ground truth data of the training data. For example, for a training sample of a training image and a training point cloud with a ground truth bounding box (and possibly with a ground truth class thereof), a loss function may be based on a difference between the training sample's ground truth and an estimated/inferred bounding box (and possibly an inferred estimated class thereof) of the training sample. Based on the loss function, the prediction model of the model may be trained (e.g., parameters such as weights of the prediction model being updated) so that the loss may be minimized or reduced. Backpropagation of the loss may be used to update the prediction model.

Operation 540 of training the prediction model may include training the prediction model and the ensemble projection network based on the loss function. For example, based on the loss function, the projection network and the prediction model of the model may be trained so that the difference between the estimated value of the training data/sample and the ground truth data of the training data may be minimized or reduced.

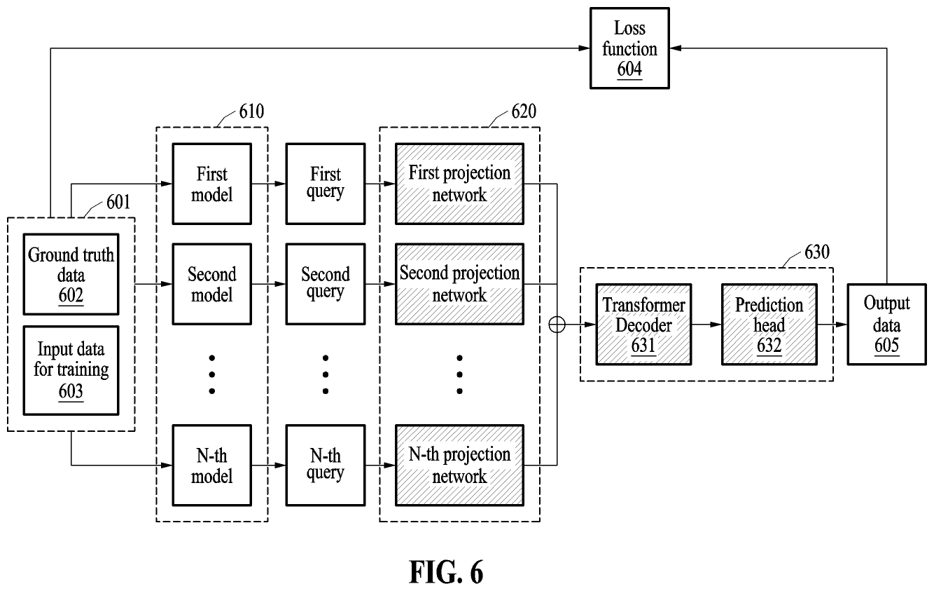

Referring to FIG. 6, training data 601 may include input data for training 603 and ground truth data 602. For example, when the ensemble model is for object detection, the input data for training 603 of the training data 601 may correspond to an image, and the correct answer data 602 may correspond to bounding box information of an object included in the input data for training 603 and class information of the object.

A loss function 604 for training the model may be defined based on a difference between output data 605 estimated by the model in response to the input data for training 603 and the correct answer data 602 of the input data for training 603 included in the training data 601. For example, the loss function 604 may correspond to a function that aims to minimize the difference between the output data 605 of the model and the ground truth data 602. A projection network 620 and a prediction model 630 of the model may be trained based on the loss function 604. As described above, the prediction model 630 may include a transformer decoder 631 and a prediction head 632. Based on the loss function 604, the projection network 620 and the prediction model 630 of the model may be trained to generate the output data 605 that is close to the ground truth data 602 of the input data for training 603.

An ensemble of transformer-based models 610 that outputs queries may be pre-trained and may not be trained based on the loss function 604. That is, the transformer-based models 610 may be frozen during training. In other words, the training method may not train the transformer-based model 610 but train the projection network 620 and the prediction model 630 of the model based on the loss function 604, thereby reducing computations for training and thus improving task performance.

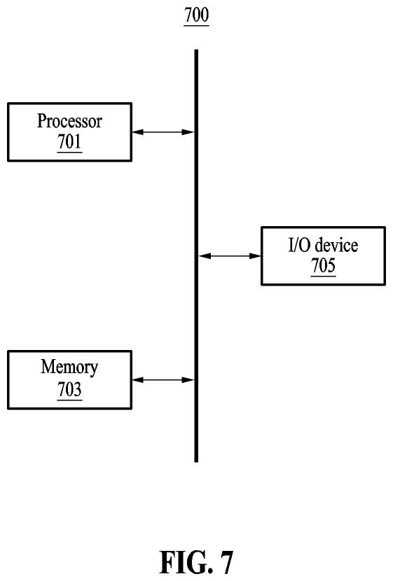

FIG. 7 illustrates an example configuration of an apparatus, according to one or more embodiments.

Referring to FIG. 7, an apparatus 700 may include a processor 701, a memory 703, and an input/output (I/O) device 705. The apparatus 700 may include an apparatus that includes the model based on feature-level ensemble described above, performs an operation of the model based on feature-level ensemble, or performs the training method based on the feature-level ensemble described above.

The processor 701 may perform at least one operation of the model based on feature-level ensemble described above with reference to FIGS. 1 to 4. For example, the processor 701 may perform at least one of obtaining, based on a plurality of transformer-based models, a plurality of queries corresponding to input data, obtaining an ensemble query corresponding to the plurality of queries, and obtaining an estimated value of the input data by applying the ensemble query to a prediction model including a transformer decoder.

The processor 701 may perform at least one operation of the training method based on feature-level ensemble described above with reference to FIGS. 5 to 6. For example, the processor 701 may train a projection network and the prediction model based on a loss function related to a difference between the estimated value of the input data and ground truth data of the input data. The processor 701 may be any of the types of processors mentioned below, or may be a combination of such processors. Moreover, one apparatus (e.g., apparatus 700) may be used for training and another apparatus may be used for non-training inference. For example, the trained ensemble model may be copied from a training apparatus to a non-training apparatus such as a system of a vehicle that may use inferences (e.g., bounding boxes, classifications, etc.) for performing driving functions such as an advanced driver assist system (ADAS), an assisted driving (ΔD) system, planning paths, and so forth.

The memory 703 may be a volatile memory or a non-volatile memory and may store data related to the model based on feature-level ensemble described above with reference to FIGS. 1 to 6. For example, the memory 703 may store data generated while the model based on feature-level ensemble performs a task, data needed for the model based on feature-level ensemble to perform the task, or data for training the model. For example, the memory 703 may store a weight of a layer of a neural network included in the model. For example, the memory 703 may store the plurality of queries corresponding to the input data obtained from the plurality of transformer-based models.

The memory 703 may not be a component of the apparatus 700 but be included in an external device accessible by the apparatus 700. In this case, the apparatus 700 may receive data stored in the memory 703 included in the external device and transmit data to be stored in the memory 703 through the I/O device 705 and/or a communication module.

The apparatus 700 may be connected to the external device (e.g., a personal computer (PC) or a network) through the I/O device 705 and exchange data with the external device. For example, the apparatus 700 may receive input data through the I/O device 705 and output an estimated value corresponding to the input data.

The memory 703 may store a program that implements an operation method of the model based on feature-level ensemble or a learning method based on feature-level ensemble described above with reference to FIGS. 1 to 6. The processor 701 may execute a program stored in the memory 703 and may control the apparatus 700. Code of the program executed by the processor 701 may be stored in the memory 703.

The apparatus 700 may further include other components not shown in the drawings. For example, the apparatus 700 may include a communication module. The communication module may provide a function for the apparatus 700 to communicate with other electronic devices or other servers through a network. In other words, the apparatus 700 may be connected to the external device (e.g., a terminal of a user, a server, or a network) through the communication module and exchange data with the external device. In addition, for example, the apparatus 700 may further include other components such as a transceiver, various sensors, and a database.

The computing apparatuses, the vehicles, the electronic devices, the processors, the memories, the image sensors, the vehicle/operation function hardware, the ADAS/AD systems, the displays, the information output system and hardware, the storage devices, and other apparatuses, devices, units, modules, and components described herein with respect to FIGS. 1-7 are implemented by or representative of hardware components. Examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. A hardware component may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in FIGS. 1-7 that perform the operations described in this application are performed by computing hardware, for example, by one or more processors or computers, implemented as described above implementing instructions or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

Instructions or software to control computing hardware, for example, one or more processors or computers, to implement the hardware components and perform the methods as described above may be written as computer programs, code segments, instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions herein, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media. Examples of a non-transitory computer-readable storage medium include read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-Res, blue-ray or optical disk storage, hard disk drive (HDD), solid state drive (SSD), flash memory, a card type memory such as multimedia card micro or a card (for example, secure digital (SD) or extreme digital (XD)), magnetic tapes, floppy disks, magneto-optical data storage devices, optical data storage devices, hard disks, solid-state disks, and any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above disclosure, the scope of the disclosure may also be defined by the claims and their equivalents, and all variations within the scope of the claims and their equivalents are to be construed as being included in the disclosure.

What is claimed is:

1. A method of operating an ensemble model based on feature-level consolidation, the method comprising:
obtaining queries by inputting a same input data item to respective transformer models, the transformer models generating respective queries from the input data item;
forming an ensemble query corresponding to the queries; and
generating a predicted value of the input data item by applying the ensemble query to a prediction model that comprises a transformer decoder, the prediction model inferring the predicted value from the ensemble query.

2. The method of claim 1, wherein the forming of the ensemble query corresponding to the queries comprises:
inputting the queries to respective projection networks that project the queries to respective projected queries that share a same feature space; and
wherein the ensemble query comprises a concatenation of the projected queries.

3. The method of claim 1, wherein the prediction model comprises the transformer decoder and a prediction network that generates the predicted value.

4. The method of claim 3, wherein the generating of the predicted value of the input data item comprises:
obtaining output embedding data by applying the ensemble query to the transformer decoder; and
obtaining the predicted value of the input data item by applying the output embedding data to the prediction network.

5. The method of claim 1, wherein
the input data item comprises an image or a point cloud, and
the predicted value of the input data item comprises a bounding box of an object detected in the input data item or class information of the object.

6. The method of claim 5, wherein the prediction model comprises:
a network configured for bounding box regression for object detection and is configured for a class estimation of an object corresponding to a bounding box.

7. The method of claim 1, wherein the prediction model comprises:
a neural network trained based on a loss function related to a difference between the predicted value of the input data item and ground truth data of the input data item.

8. The method of claim 2, wherein the projection networks and the prediction model comprise:
a neural network trained based on a loss function related to a difference between the predicted value of the input data item and ground truth data of the input data item.

9. The method of claim 2, wherein the queries have different dimensions and the ensemble query is based on respective transformations of the queries that have a same dimension.

10. A method of training an ensemble model based on feature-level consolidation, the method comprising:
obtaining queries by inputting a same training data item to respective transformer models, the transformer models generating respective queries from the training data item;
obtaining an ensemble query corresponding to the plurality of queries;
obtaining an estimated value of the training data item by applying the ensemble query to a prediction model comprising a transformer decoder; and
training the prediction model based on a loss function related to a difference between the estimated value of the training data item and ground truth data of the training data item.

11. The training method of claim 10, wherein the obtaining of the ensemble query comprises:
obtaining projected queries corresponding to the queries based on respective projection networks that embed the queries into a same feature space; and
obtaining the ensemble query by concatenating the projected queries.

12. The training method of claim 11, wherein the training of the prediction model comprises:
training the prediction model and the projection network based on the loss function.

13. The training method of claim 10, wherein
the training data item comprises an image or a point cloud,
the estimated value of the training data item comprises a bounding box of an object detected in the input data item and a classification of the object, and
the prediction model comprises a network that is configured for bounding box regression for object detection and classification in the training data item.

14. The training method of claim 10, wherein the obtaining of the estimated value of the training data item comprises:
obtaining output embedding data by applying the ensemble query to the transformer decoder of the prediction model; and
obtaining an estimated value of the training data item by applying the output embedding data to a prediction network of the prediction model, the prediction model inferring the estimated value of the training data item from the output embedding data.

15. A non-transitory computer-readable storage medium storing instructions that, when executed by a processor, cause the processor to perform the method of claim 1.

16. An apparatus comprising one or more processors configured to:
generate, by transformer-based models, respective queries corresponding to an input data item inputted to the transformer-based models;
obtain an ensemble query corresponding to the queries; and
obtain a predicted value of the input data item by applying the ensemble query to a prediction model comprising a transformer decoder.

17. The apparatus of claim 16, wherein the one or more processors are further configured to, in obtaining the ensemble query:
obtain projected queries respectively corresponding to the queries, wherein the projected queries are obtained based on a projection network that projects the queries into the projected queries which are in a same feature space; and
wherein the ensemble query comprises a concatenation of the projected queries.

18. The apparatus of claim 17, wherein the projection network and the prediction model comprise:
a neural network trained based on a loss function related to a difference between the estimated value of the input data item and ground truth data of the input data item.

19. The apparatus of claim 17, wherein the one or more processors are further configured to:
train the projection network and the prediction model based on a loss function related to a difference between the estimated value of the input data item and ground truth data of the input data item.

20. The apparatus of claim 16, wherein
the input data item comprises an image and a point cloud,
the predicted value of the input data item comprises a bounding box of an object detected in the input data item or a classification of the object.
